(19) United States
(12) Patent Application Publication
(10) Pub. No.: US 2022/0273406 A1
(43) Pub. Date: Sep. 1, 2022

(54) DENTAL APPARATUS

(71) Applicant: Jay TANNA, Ickenham (GB)

(72) Inventor: Jay TANNA, Ickenham (GB)

(21) Appl. No.: 17/631,124

(22) PCT Filed: Jul. 21, 2020
(86) PCT No.: PCT/GB2020/051734

§ 371 Date: Jan. 28, 2022

(30) Foreign Application Priority Data
Jul. 29, 2019 (GB) 1910812.5

(51) Int. Cl. A61C 17/18; A61C 17/20; A61C 17/00; A61C 17/22; A61C 17/34

(52) U.S. Cl. CPC A61C 17/18; A61C 17/20; A61C 17/005; A61C 17/222; A61C 17/34

(57) ABSTRACT

A dental apparatus for tooth stain removal comprising an elongate body formed of a single piece of plastic. The dental apparatus comprising a distal portion of the body having a distal end for contacting a tooth, wherein the distal portion is pointed and angled relative to an axial direction of the body for contacting and removing stains from a tooth. The dental apparatus further comprising a proximal portion of the body configured to attach onto an electric toothbrush drive mechanism such that driving of the electric toothbrush drive mechanism causes the distal portion of the body to vibrate.

### CROSS-REFERENCE TO RELATED APPLICATIONS

This application is a national phase application of International Application No PCT/GB2020/051734, filed Jul. 21, 2020, which claims priority to Great Britain Patent Application Serial No. 1910812.5, filed Jul. 29, 2019, all of which are incorporated herein by reference.

### FIELD OF THE DISCLOSURE

The present invention belongs to the field of dental apparatus. In particular, embodiments of the invention relate to apparatus for tooth stain removal.

### BACKGROUND

Stain removal and polishing is a popular practice for improving the visual appearance of a tooth or teeth. Dentists and hygienists are trained for performing these tasks using specially designed tools, however, there is a growing desire for individuals to perform stain removal and/or polishing at home. Tips, such as dental scalers, for removing plaque and tartar and polishing the surface of a tooth are typically made of metal, which has to be carefully used on a tooth. Training is usually required to use such dental tools. Metal tips are sharp and can cause injury to the gums if not used correctly, for example, by inexperienced users or non-trained professionals.

### SUMMARY

Aspects of the invention are set out in the independent claims and preferred features are set out in the dependent claims.

According to a first aspect there is provided a dental apparatus for stain removal and/or tooth polishing comprising: an elongate body made from a single piece of plastic, and comprising: a distal portion of the body having a distal end for contacting a tooth, wherein the distal portion is pointed and angled relative to an axial direction of the body for contacting and removing stains from and/or polishing a tooth; and a proximal end of the body configured to attach onto an electric toothbrush drive mechanism such that driving of the electric toothbrush drive mechanism causes the distal portion of the body to vibrate.

The apparatus is an attachable tip (similar to the brush heads of electric toothbrushes) which can be attached to any electric toothbrush. Patients often go to see a dentist or hygienist to have stains removed from their teeth, however, this dental apparatus can be used without training and is therefore more safe to be used at home compared to the tools used in dental clinics, such as scaler devices. The proximal end is configured to attach to a toothbrush drive mechanism that is also operable to operate an electric toothbrush head. The apparatus can be easily detached from the toothbrush, just like the brush heads that are typically used with such devices.

The elongate body is a single piece of plastic, which is advantageous from a manufacturing perspective, as well as improving the performance of device. The elongate body being formed of a single piece means the operable part of the elongate body is a formed from a single piece of plastic, such that both the distal portion having the tooth contacting distal end and the proximal portion that can be attached to an electric toothbrush drive mechanism are formed as a single piece.

Forming the tip of plastic makes it easier for consumers to use at home without any fear of damaging their gums or teeth and also provides an option to replace these tips on a regular basis. Polycarbonate has been shown to have advantages over other types of plastics for its rigidity and strength, as well as resilience to deformation. Polycarbonates are a group of thermoplastic polymers containing carbonate groups. One example polycarbonate that may be used in the dental apparatuses described herein is a polycarbonate formed from bisphenol A, but other polycarbonates are also possible.

The polycarbonate plastic may comprise, for example reinforced with, glass fibre between around 10% and 40% glass fibre by weight, preferably between around 20% and 30%. The amount of glass fibre may be between 0% and 30%. Optionally, there may be around 10% or 20% or 30% or 40% glass fibre mixed with the polycarbonate. In some embodiments the polycarbonate may be reinforced with more than 10% glass fibre. In other embodiments, the polycarbonate may be reinforced with less than 30% glass fibre. In one embodiment, the plastic material is polycarbonate comprising between around 8% and 12% glass fibre. In another embodiment, the plastic material is polycarbonate comprising between around 18% and 22% glass fibre. In yet another embodiment, the plastic material is polycarbonate comprising between around 28% and 32% glass fibre. In some embodiments glass fibre content may be at least around 5% and/or up to around 50% by weight.

Advantageously, reinforcing the polycarbonate with glass fibre can further improve the strength of the dental apparatus. This beneficially aids in removing stains from the teeth and/or polishing and prevents deformation of the tip by making it more resilient to wear and tear from continued use and may prolong the useful lifetime of the tip. It has been found that glass fibre can improve the strength of the stain removal/polishing tip and may reduce degradation of the tip over time (e.g. by flakes of polycarbonate chipping off the tip during use). Forming the stain removal tip of around 30% glass fibre reinforced material may demonstrate higher strength, rigidity, creep strength and dimensional stability than unreinforced polycarbonate. These properties and good fatigue strength make glass filled polycarbonate material suitable for use in parts that are exposed to high static loads over long periods in high temperature conditions. The glass fibre is added to a certain percentage because it may be difficult to manufacture the product with a higher percentage, for example 60% glass fibre to 40% polycarbonate would be difficult to manufacture, due to its moulding properties. The tip will also be more brittle with higher percentages of glass fibre, which may cause unwanted deterioration of the tip in use.

Optionally wherein the surface of the distal end has a longest dimension (or length) of between around 2 mm and 10 mm, preferably at least 2.5 mm, more preferably at least 3 mm or at least 4 mm. The longest dimension may also be less than around 6 mm or 5 mm. The surface of the distal end, refers to the end surface of the distal part that is arranged to contact a tooth, also referred to as the tooth contacting surface of the distal end. Conventional dental scalers used in dental practices tend to have a longest dimension of the tooth contacting surface of less than 1 mm.

In certain embodiments, in use, the vibrations of the dental apparatus may clean tooth staining and/or polish a tooth. Plaque and/or stains on a tooth may be removed by being loosened by the vibrations imparted by the vibrations at a location at which the pointed end of the dental apparatus is in contact with the tooth. The vibrations can optionally be provided by an electric toothbrush drive mechanism, however, other motorised tools such as purpose built scaler or polishing apparatus may also be used with the attachable tip. The vibrating of the distal portion means the distal end vibrates. The elongate body is configured such that when attached to an electric toothbrush and driven by the electric toothbrush drive mechanism, the vibrations of the distal end of the body are capable of polishing or removing stains from teeth. The amplitude and frequency of the vibrations and composition of the elongate body may thus provide polishing or stain removal functionality. Such configuration may comprise selecting the materials and size and shape of the elongate body provides the elongate body with a particular resonant frequency. For example, in some embodiments the tip may be designed such that driving of the electric toothbrush drive mechanism causes the distal end of the body to vibrate with an amplitude of around 0.1 mm to 5 mm, more preferably around 0.3 mm to 1 mm.

Optionally, the surface area of the pointed distal end can be between 0.05 mm² and 2 mm², preferably between 0.1 mm² and 0.5 mm², more preferably around 0.16 mm². In preferred embodiments the tooth-contacting surface area is less than 0.3 mm² or less than 0.2 mm². The surface area of the pointed distal end is generally a surface area arranged to contact a tooth of a user in use.

The elongate body can optionally have a surface area of the pointed distal end that is greater than 0.05 mm² and/or that is less than 3 mm². In some embodiments, the distal pointed distal portion of the tip can have a generally frustoconical shape. In other embodiments, however, the distal pointed end may be conical, narrowing to a sharp point. In some embodiments the tip is pointed in a substantially point-like configuration, however, in other embodiments, the tip may be pointed such that the pointed end has a substantially two dimensional configuration, for example, the pointed end may be substantially linear in the plane of the surface of the tooth to which it will touch, in use. In some embodiments the surface of the distal end is rectangular, having a width and a length. The length is generally substantially greater than the width.

The tip of the dental apparatus according to certain embodiments is similar to a dental apparatus used in dental clinics. However, the design has been advantageously modified such that it can provide a much larger, for example wider, area that contacts the tooth compared to a device used at a dental clinic, enabling the user to clean a larger area of the tooth. Variants of the dimensions of the tip may also be manufactured to be comparable to current dental tools, however, which have a smaller surface area. The surface area of the tip being larger than that seen in dental clinics beneficially improves the safety of using the tip in a home environment by reducing the chance of causing an injury by, for example, decreasing the possibility of cutting the gums by virtue of the greater surface area of the tip. This design is different to existing products designed for home use and is also different to the dental scaler or polisher which may be used in a dental clinic.

The dental apparatus may be configured such that driving of the electric toothbrush drive mechanism causes the distal portion (and thus the distal end) of the body to vibrate. The vibrations may have a frequency within the sonic range of between 20 Hz and 20 KHz, and may have a typical frequency of between 200 to 400 Hz. The frequency of these vibrations is significantly lower than that of standard scaler devices used by dental professionals, which reduces the risk of harm to the tooth and/or gums, making this device suitable for home use by untrained users. Configuring the dental apparatus to have vibrations of such an amplitude and/or frequency may comprise selecting the composition of the material and/or the size and shape of the elongate body, such that the resonant frequency matches or is close to a particular frequency, for example 200 Hz, 300 Hz or 400 Hz. In some embodiments ultrasonic toothbrushes may be used, and the dental apparatus may be configured to operate in the ultrasonic range, e.g, 20 kHz or more, for example between around 1 MHz and 5 MHz, preferably between 1 MHz and 2 MHz.

Optionally, the distal portion is angled at between 30 degrees and 60 degrees from the axial direction of the body, more preferably between 35 degrees and 45 degrees, such as around 40 degrees. Orienting the tip at an angle from the axial direction of the body advantageously provides for a user to be able reach all parts of the tooth, in particular the back of the tooth that faces into the user's mouth.

Optionally, the proximal end of the body may comprise a cavity, in a substantially longitudinal direction from a proximal end of the proximal portion, configured to receive the electric toothbrush drive mechanism. The cavity may extend along the axial direction of the elongate body. A cavity in the body of the tip at a proximal portion can advantageously be manufactured to fit and attach to any style of electric toothbrush and may be used with any electric toothbrush available to purchase, for example a standard commercial electric toothbrush which a user would already have at home. Instead of investing in a whole stain removal unit to clean stains at home, as is currently the only option, a user can instead buy and use these attachable tips which can be easily detached and interchanged with the normal brush heads. The dental apparatus may optionally be attached to any electric toothbrush drive mechanism. The length of the cavity may be between 1 cm and 5 cm, for example around 3 cm.

A further internal cavity may optionally be present in the body of the dental apparatus for transporting fluid within the body. This internal cavity may be in the form of a lumen for transporting the fluid within the body. An aperture may also be present at or proximate to the distal pointed end for expelling the fluid, for example water, at the site of the stain removal and/or polishing action on the tooth, in use. In some embodiments the aperture is up to around 5 mm from the distal pointed end, for example between 1 mm and 5 mm, or between 2 mm and 4 mm from the distal end. The location of the aperture may be altered to improve ease of manufacture. Advantageously, cleaning or flushing at the site of stain removal and/or polishing can remove dirt and debris from the treatment area. Fluid can also be used to cool the tip, which may heat up due to the imparted vibrations and friction between the tooth and the dental tip.

Optionally, wherein the aperture at the distal pointed end for expelling the fluid has a length of between around 0.5 mm and 1 mm, preferably between around 0.6 mm and 0.9 mm.

Optionally, the dental apparatus may also be provided with a motor for expelling the liquid from the tip at the distal pointed end, such as to allow flushing to occur. The dental apparatus may further optionally comprise a reservoir wherein the liquid, for example water, can be stored. A reservoir may be provided, for example, within the attachable tip where it can be easily refilled or, for example, the fluid may be provided by a running tap.

The dental apparatus may further comprise a coupling mechanism to attach the body to the toothbrush drive mechanism, preferably wherein the coupling mechanism enables a click-fit between the dental apparatus and an electric toothbrush. In other embodiments, a screw-fit or snap-fit coupling may be used. The secure coupling provides for ease of replacement of the removable tip, which must also be secure, for example tight enough to maintain the dental tip in position in use whilst the distal end is vibrating. In some embodiments, the coupling mechanism is provided as part of a sleeve, which can be formed of a separate piece of plastic, which is secured or attached to the elongate body.

The plastic from which the dental apparatus is made can optionally be transparent, for example clear. In other embodiments, the plastic can be opaque and/or coloured. This may be appealing to a consumer.

There may also be provided a kit comprising at least one tooth stain removal and/or polishing dental apparatus as described above and an electric toothbrush, wherein the dental apparatus is arranged to be coupled to the drive mechanism of the electric unit of the electric toothbrush. The kit may further comprise an electric toothbrush head, which can also be coupled to and driven by the drive mechanism of the electric toothbrush. In some examples, the kit is provided having a plurality of such tooth stain removal and/or polishing dental apparatuses and a plurality of electric toothbrush heads. In some embodiments, the electric unit may be provided by a unit that is not an electric toothbrush drive mechanism, for example, an electric unit may be a purpose built electric unit for stain removal or another unit suitable to provide vibration.

According to a second aspect there is provided a dental apparatus for tooth stain removal and/or polishing and/or scaling comprising: a scaler tip for a dental scaler comprising: an elongate body formed of a single piece of plastic; a distal portion of the body having a distal end for contacting a tooth, wherein the distal portion is pointed and angled relative to an axial direction of the body for contacting and scaling a tooth; and a proximal portion of the body configured to couple to a drive mechanism such that driving of the drive mechanism causes the distal portion of the body to vibrate.

The dental scaler may be similar to the tooth stain removal and/or polishing dental apparatus described above, however, it may be modified such that it can be used with a dental scaler apparatus that might usually be found in a dental clinic. Such apparatus may be usable by, for example, trained personnel in a dental clinic environment. For example, by dentists and hygienists that have access to scaling and polishing equipment and are not restricted to using the drive mechanism of a commercial electric toothbrush.

Typical metal scalers require sterilisation between uses, however, the plastic tip is a single use product and thus does not require sterilisation. This is beneficial to patients, who will not suffer if the scaler is not properly sterilised between uses and the dentist who will save time by simply replacing the tip.

The elongate body of the scaler tip may optionally comprise a plastic that is a polycarbonate, as described above. The polycarbonate may optionally comprise between around 10% and 40% glass fibre by weight, preferably between around 20% and 30%.

The distal portion (and therefore the distal end) is optionally configured to vibrate with a frequency of 20 KHz or over. A maximum vibration frequency may be up to 3 MHz. Dental scalers typically operate with frequencies in the ultrasonic range. The drive mechanism to which the tip may be coupled can provide these ultrasonic frequencies. The scaler tip may further comprise an internal cavity within the elongate body for transporting a fluid within the body; and an aperture at or proximate the distal pointed end for expelling the fluid. The cavity could, for example, be a lumen for transporting the fluid. This can be used to cool the tip (which is particularly useful when the tip is driven with a high frequency of 20 kHz or more, since high frequency vibrations create excessive heat). Advantageously, cleaning or flushing at the site of stain removal and/or polishing can remove dirt and debris from the treatment area.

Optionally, the aperture at the distal pointed end for expelling the fluid has a length (or longest dimension) of between around 0.5 mm and 1 mm, preferably between around 0.6 mm and 0.9 mm.

The tooth contacting surface of the distal end may have a longest dimension of between around 0.5 mm and 2.5 mm, preferably at least 0.6 mm, more preferably between 0.8 mm and 2 mm. This is comparable to normal dental scaler apparatus. Generally the width of the surface will be between around 0.1 mm and 0.8 mm, preferably between around 0.2 mm and 0.4 mm.

There is also described herein a scaler apparatus comprising a scaler tip as described above and a scaler drive apparatus comprising a handle and a scaler drive mechanism for causing the distal portion of the scaler tip to vibrate.

Preferably the scaler tip is detachable from the handle and drive mechanism. The scaler apparatus may be provided as a kit of parts, having a scaler drive apparatus and a plurality of detachable scaler tips.

Optionally, where the scaler tip has an aperture and internal cavity or lumen for transporting fluid within the body, the scaler drive apparatus may also be provided with a motor for expelling the fluid from the tip at the distal pointed end, such as to allow flushing to occur. The dental apparatus may further optionally comprise a reservoir wherein the liquid, for example water, can be stored. A reservoir may be provided, for example, within the scaler tip or within the handle of the scaler drive apparatus, where it can be easily refilled or, for example, the fluid may be provided by a running tap.

According to a third aspect there is provided a dental apparatus for tooth stain removal and/or polishing comprising: an elongate plastic body comprising; a distal portion of the body having a distal end for contacting a tooth, wherein the distal portion is pointed and angled relative to an axial direction of the body for contacting and removing stains from and/or polishing a tooth; and a proximal end of the body configured to attach onto a drive mechanism, for example a dental scaler or polisher apparatus drive mechanism or an electric toothbrush drive mechanism, such that driving of the drive mechanism causes the distal portion of the body to vibrate. This dental apparatus may have some or all of the other features associated with the dental apparatus for stain removal as discussed above.

According to a fourth aspect there is provided a dental apparatus for stain removal and/or tooth polishing comprising: an elongate body made from a single piece of plastic, comprising: a distal portion of the body having a distal end for contacting a tooth, wherein the distal portion is pointed and angled relative to an axial direction of the body for contacting and removing stains from and/or polishing a tooth; and a proximal end of the body configured to attach onto an electric unit comprising an electric drive mechanism such that driving of the electric drive mechanism causes the distal portion of the body to vibrate. Thus in this aspect the drive mechanism is provided by an electric drive unit that is not necessarily an electric toothbrush drive mechanism, for example the drive unit may be specifically designed for the stain removal dental apparatus/tip. Advantageously, a plastic elongate body provides a disposable product, which does not require re-sterilising (as a metal one would). Additionally, the elongate body formed of plastic provides a stain removal apparatus that is safer for the untrained user to use without damaging their teeth or gums. This dental apparatus may have some or all of the other features associated with the dental apparatus for stain removal as discussed above. For example, a kit of parts may be provided which has an electric unit comprising an electric drive mechanism and one or more elongate bodies for attachment to the drive mechanism.

Any system feature as described herein may also be provided as a method feature, and vice versa. As used herein, means plus function features may be expressed alternatively in terms of their corresponding structure.

Any feature in one aspect of the invention may be applied to other aspects of the invention, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

### BRIEF DESCRIPTION OF THE DRAWINGS

Exemplary embodiments are illustrated in the accompanying figures in which:

FIG. 1 illustrates an exemplary dental apparatus.

FIG. 2 illustrates an exemplary dental apparatus attached to an electric toothbrush.

FIGS. 3 and 4 illustrate an exemplary top view of an exemplary dental apparatus.

FIG. 5 illustrates an exemplary bottom view of an exemplary dental apparatus.

FIGS. 6, 7, 8 and 9 illustrate an exemplary dental apparatus from perspective, front, side and sectional views.

FIG. 10 illustrates an exemplary base unit of a dental apparatus.

FIG. 11 illustrates an exemplary sleeve of a dental apparatus.

FIG. 12 illustrates an exemplary connector unit of a dental apparatus.

FIG. 13 illustrates an exemplary cap of a dental apparatus.

FIG. 14 illustrates an assembly of the elements of an exemplary dental apparatus.

### DETAILED DESCRIPTION

An attachable tooth stain removal and/or polishing/scaling tip comprises a distal end having a pointed end 15 and a proximal end 30 suitable to be attached to, for example, an electric toothbrush or a purpose built scaling or polishing dental tool. Typically the tip is around 3 mm wide by between 50 mm and 85 mm, for example 65 mm long.

The pointed end of the tip is angled at approximately 40 degrees from the axial direction main body such that it can contact the surface of a tooth. The dental apparatus tip has been made with a specific material and shape such that a user can use it at home with ease. The tip has been designed primarily for home use and is more suitable than conventional dental scaling apparatuses being used in dental clinics. Dental clinic scalers have very sharp metallic tips, with which an untrained user may cause damage to their teeth and gums. The non-metallic (generally plastic) material selected here reduces the possibility of damage. In addition, the tooth contacting surface of the distal end is generally larger than that of a conventional dental scaler.

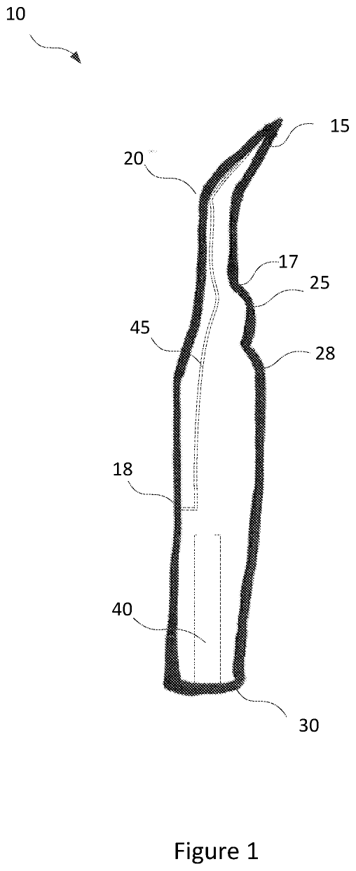

FIG. 1 illustrates an exemplary dental apparatus 10 according to an embodiment of the present invention. The dental apparatus 10 comprises a main body having a pointed end 15 which narrows to a point at one end of the body, and a base 30 at the other end of the body. The body is substantially cylindrical on the outside until it narrows and angles away from the substantially axial directions at the shoulder 28, which is a point along the main body towards the distal pointed end 15. There are small edges around the outside of the tip which helps in locking with the outer sleeve (described later).

The pointed end 15 is configured with a surface area of the point between 0.1 mm² and 1.8 mm² When in contact with a tooth, polishing and/or stain removal is performed at the site of contact between the tooth and the point. The design of the dental apparatus as shown in FIG. 1 differs to a typical, metal scaler, with the end surface having a greater surface area that covers a larger area of the tooth. The surface of the pointed end that contacts the tooth can be circular, or may be elliptical or rectangular. In the case that it is not circular, the pointed end 15 may have a width and a length, wherein one of the width or the length is a longest dimension and is substantially longer than the other. The longest dimension may be an edge, for example. For example, the tooth contacting surface may have a length (or longest dimension) of between 0.5 mm and 10.0 mm and a width (at the widest point) of between 0.1 mm and 1.0 mm.

In one embodiment the tooth contacting surface has a length of at least 3.0 mm, or at least 3.1 mm. Generally the length (or longest dimension) of the tooth contacting surface is less than 10.0 mm, or less than 8.0 mm. The width of the surface at the widest point may be between 0.2 mm and 0.5 mm.

The pointed end 15 is angled away from the axial direction of the main body at the point 20. The angle made at point 20 is approximately 40 degrees relative to the axial direction of the main body.

The main body has an extrusion 25 disposed below the angled point 20 and the pointed end 15 and is configured to provide support to the more delicate and thinner pointed end 15 of the dental apparatus. A shoulder 28 is disposed between the angled pointed end 15 of the main body and the base 30 and also helps provide stability to the pointed end 15.

The main body, at the end opposite to the pointed end 15, comprises a base 30 at which an electric toothbrush drive system, or other appropriate drive mechanism, can be attached. The base 30 may be configured to comprise a cavity 40 to receive a driving mechanism of, for example, any electric toothbrush. As is shown in FIGS. 8-9, the cavity 40 has a length of 30 mm. The cavity 40 is rectangular in cross-section and has a width of 3.20 mm in one direction and a width of 1.79 mm in a perpendicular direction. Although cavity 40 is shown as straight, in some embodiments the cavity may be curved to accommodate a curved fitting for a toothbrush (or other) drive mechanism.

A further cavity 45 may be used for expelling a fluid at an aperture 17 at or near the pointed end 15. The cavity 45 may be connected to an aperture 18 on the opposite side of the tip, from which point a fluid, such as water, may enter the tip and travel in a direction along the cavity and towards the aperture 17. The aperture 17 may be positioned near the tip, for example as shown in FIG. 1 at the shoulder 25 so that a fluid directed through the aperture can flush the surrounding area to get rid of debris and/or to cool the tip.

The tip uses the sonic movement of the vibrations of an electric toothbrush drive mechanism to help clean stains on teeth. The pointed end 15 is placed onto the surface of the tooth, for example, where there is a stain or blemish. The vibrations cause material that has been built up on the exterior of the tooth surface, for example plaque, to loosen and/or be scratched off the exterior surface of the tooth. Depending on the electric unit of the electric toothbrush, the vibrations may occur, for example, linearly and in-line with or perpendicular to the longest dimension of the contacting surface. In other examples, vibrations will be in a circular or in a rotational direction.

The cavity 45 that is connected by apertures 17 and 18 may be further connected (from aperture 18) to a reservoir of a fluid and/or a motor. The motor can be configured to pump water, or other suitable fluids, through the cavity 45 to the aperture 17 and onto or around the tooth and/or mouth. This can help to flush the area around the tooth at which the stain removal and/or polishing process is taking place; removing debris that has been dislocated from the surface of the tooth during the stain removal and/or polishing process. Water, or other cooling fluids, may also be provided to cool the apparatus if it gets too hot, for example, as a result of extended exposure to vibrations.

A mechanism similar to a commercially available water flosser may be combined with the sonic vibrations provided by an electric toothbrush drive mechanism to create a dental apparatus that can both expel water at the distal end and vibrate to remove plaque and other debris on the surface of a tooth.

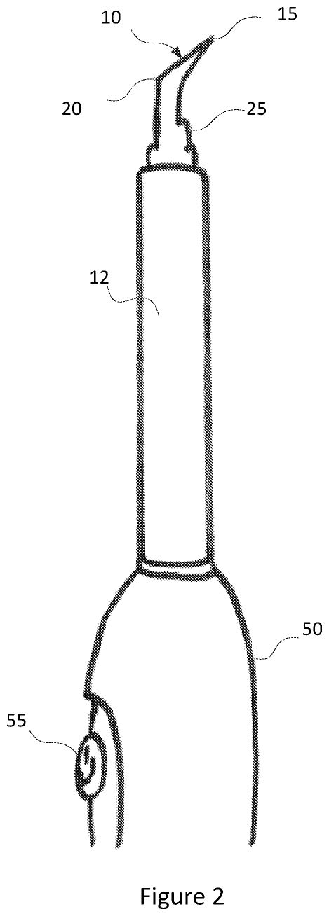

FIG. 2 illustrates an exemplary dental apparatus 10 according to an embodiment of the present invention attached to an electric toothbrush 50.

The attachable stain removal head/tip 10 of FIG. 1 may be attached to a sleeve 12 having a length of around 50 mm, for example 52 mm. The tip and sleeve ensemble are then capable of being attached to the head of an electric toothbrush 50.

In some embodiments the sleeve 12 may be detachable from the tip 10, however, the tip and sleeve 12 may be fabricated using a single piece of material such that the ensemble of the tip 10 and the sleeve 12 comprise a single unit. In other embodiments, the sleeve may be a separate component to which the tip may be attached or fit. The sleeve does not need to be made from the same material as the tip itself, for instance if the sleeve is a separate component it may be made from any material.

In use, the power button 55 of the electric toothbrush 50, when pressed, initiates the drive mechanism and provides vibrations for the dental apparatus tip/head to act to remove stains from teeth. The sonic and/or rotating vibrations agitate stains and/or plaque on the enamel (the outer layer of the tooth) that may build up over time from consumption of food and drinks, and/or from smoking. Although in FIG. 2 the pointed distal end of the tip is angled outwards from the toothbrush handle on the opposite side to the button 55 of the toothbrush, in other embodiments the distal end of the tip is angled outwards on the same side and the button of the electric toothbrush.

A material that the dental apparatus 10 (and/or sleeve 12) can be made from is polycarbonate. Glass fibre can reinforce polycarbonate to further improve the strength of the tip, which may also help with stain removal and reduce grinding and/or wear of the pointed end as it polishes the tooth. The weight percentage of glass fibre added to polycarbonate is typically between 10% to 30% glass fibre. In general, the material is not limited to being polycarbonate; other plastics may be suitable.

Polycarbonate provides high impact resistance and is safe to use in and around the mouth. Additional coatings can be used to prevent scratching. Its thermoplastic properties also mean in it can be easily manufactured, using a number of techniques. For example: extrusion, injection moulding, 3D printing and cutting, for example, on a lathe. It is also possible to use BPA free polycarbonate.

The tip can be made using transparent plastics as well as those which can be opaque and coloured using any desired colour, which is gives an aesthetic appearance that is appealing to a user.

Tests using different types of plastics were performed on Acrylonitrate butadiene styrene, Polyoxymethylene, Polyporpylene and Polyacetyl. However, polycarbonate plastic provided the best results for home use. Benefits of this material include the degree of hardness/rigidity suitable to provide a sharp enough edge/point without being too sharp such that it is unsafe or difficult to use and shows resilience to deformation over repeated use. Other benefits include most effective stain removal, break resistance, reduced cost and ease of manufacturability compared to other materials.

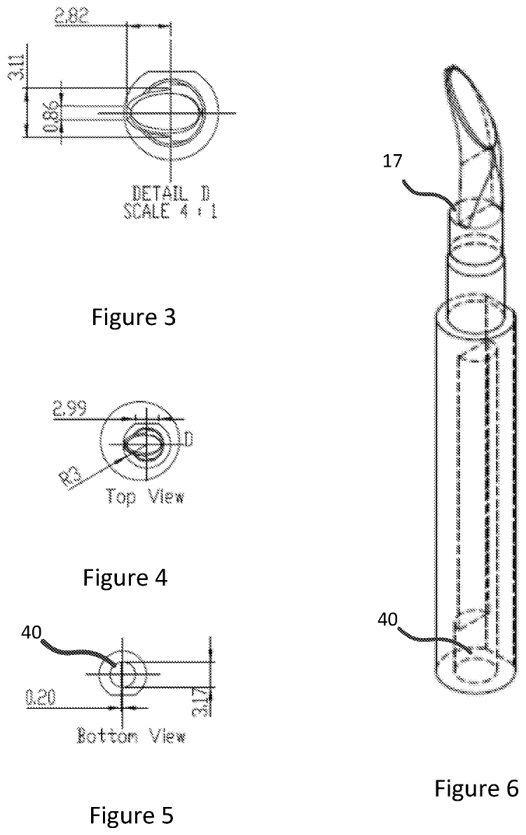

FIGS. 3 and 4 illustrate a top view of the dental apparatus. The shape of the tip can be seen to be frustoconical from the top view. The tip extends outwards from the axial direction of the body.

FIG. 5 illustrates a bottom view of the dental apparatus. The cavity 40 provides a cavity for any electric toothbrush mechanism to fit into.

FIGS. 6, 7, 8 and 9 illustrate exemplary dental apparatus, where the internal features, such as the cavity 40, or features that cannot be viewed from the angle at which the tip is positioned, are marked in dashed lines. For example, the cavity 40 may be between around 2 cm to around 5 cm in length.

Depending on the make and model of the electric unit, for example of the toothbrush or dental scaler equipment used, the dimensions of the cavity may be altered to ensure a connection can be made.

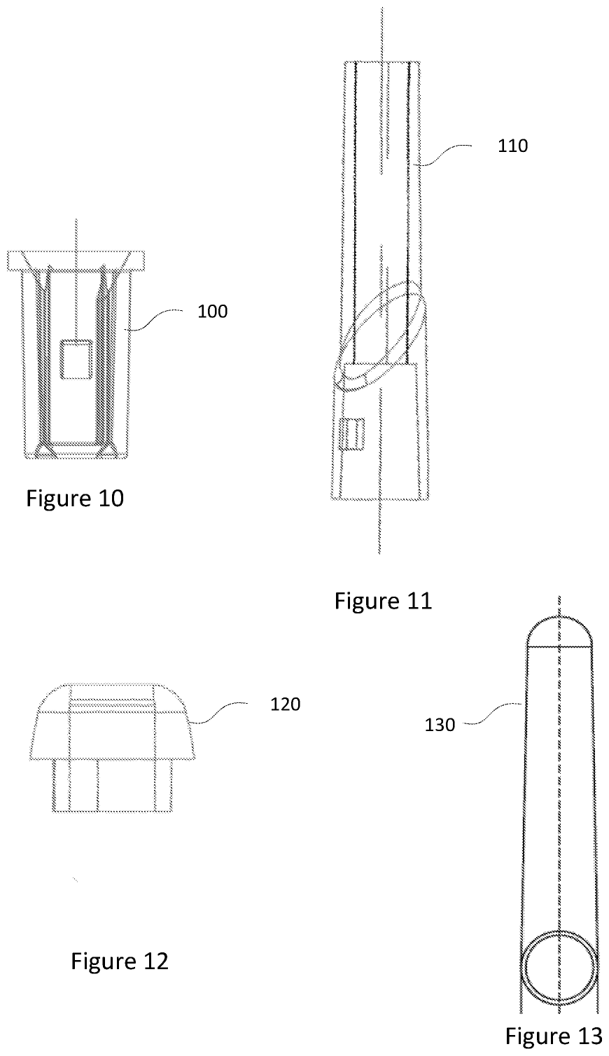

FIG. 10 illustrates an exemplary base unit 100. The base unit 100 acts as an interface between the dental tip 10 and the drive unit. It may be attached to a toothbrush (or other) drive mechanism. In some embodiments, the base unit may comprise a drive mechanism for driving the dental tip 10. In other embodiments the base unit 100 may also comprise a reservoir and/or a pump connected to a reservoir to drive water through the dental apparatus up towards the aperture 17 near the top of the pointed end 15 of the tip 10. In some embodiments, the base unit 100 is hollow, comprising a cavity suitable for the dental tip 10 to fit through. The base unit has a height of around 18 mm and a diameter of around 12 mm at a widest point.

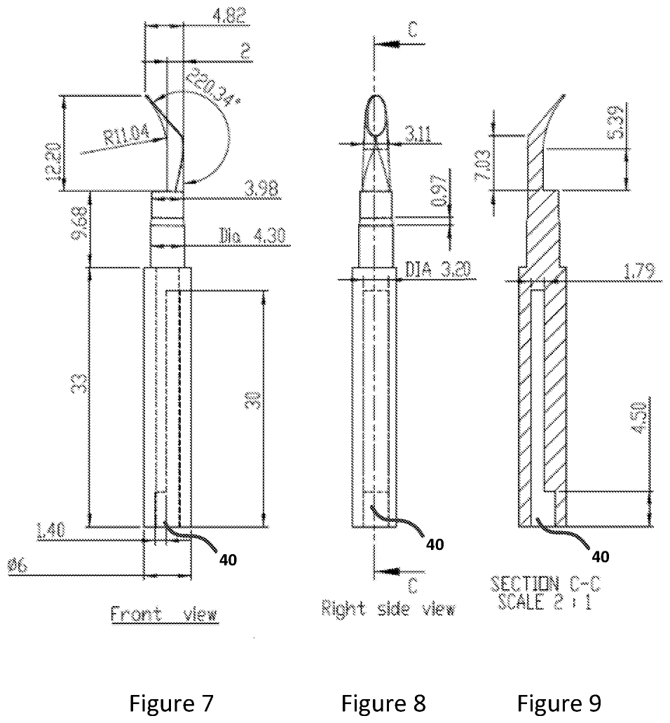

FIG. 11 illustrates an exemplary sleeve 110. The sleeve 110 may be connected to the base unit 100 at one end (for example covering or surrounding the base unit) and may be configured to receive the dental tip 10 through a hollow cavity running the length of the sleeve. In other embodiments, the sleeve 110 may connect directly with a toothbrush or other drive unit instead of the base unit 100. The length of the sleeve 110 is around 52 mm, which corresponds to substantially the length of the dental tip 10 which fits in the cavity of the sleeve 110. The sleeve 110 has an outer diameter of around 12 at a widest point where it is in contact with the base unit, and an outer diameter of around 9 mm at the thinnest point. The inner diameter is around 6 mm or may have a diameter just wider than the dental tip 10 to accommodate the dental tip 10. The tip 10 may have a diameter at the proximal end of around 6 mm or slightly less than the sleeve 110. For example, the tip may have an outer diameter of 6 mm, as shown in FIG. 7, and the sleeve may have an inner diameter of 6.3 mm. This allows the tip 10 to be inserted into the cavity and for the fitting to not be too loose or too tight.

FIG. 12 illustrates an exemplary connector unit 120 that secures the sleeve 110 to the tip 10. The connector unit 120 has a widest diameter of around 9 mm and comprises a hollow centre having a diameter suitable to fit a distal portion of the elongate body of the dental tip 10 through, which might be, for example, around 4 mm in diameter. The sleeve 110 fits into the connector unit 120 at one end, and the dental tip 10 is configured to extend through a hollow centre. The connector unit 120 helps construction of the dental apparatus by securing the tip 10 to the sleeve 110, for example by a click fit connection.

The use of the connector unit 120 and the sleeve 110 allows the distal end of the dental tip 10 to vibrate, whilst providing a secure connection to the drive mechanism.

FIG. 13 illustrates an exemplary cap 130 that may cover the combined elements of the base unit 100, the sleeve 110, the connector unit 120 and the tip 10. In other embodiments, the cap 130 may cover: only the tip 10, the tip 10 and the sleeve 110 combined, the tip 10, the sleeve 110 and the connector 120. The cap 130 may be used to protect the dental apparatus and/or to cover it whilst not in use. The cap 130 may be arranged to connect to the sleeve 100.

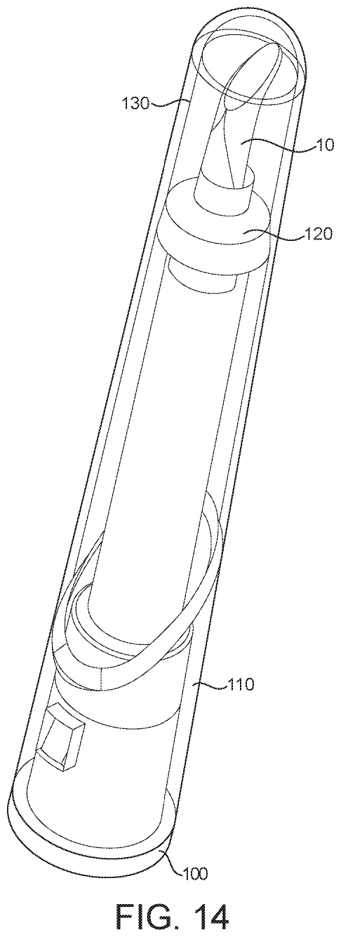

FIG. 14 illustrates an assembly of the elements of the dental apparatus including a base unit 100, a sleeve 110, a connector unit 120, a dental tip 10 and a cap 130. As can be seen, the distal portion of the dental tip 10 extends from the sleeve 110, above the connector unit 120.

The above embodiments and examples are to be understood as illustrative examples. Further embodiments, aspects or examples are envisaged. It is to be understood that any feature described in relation to any one embodiment, aspect or example may be used alone, or in combination with other features described, and may also be used in combination with one or more features of any other of the embodiments, aspects or examples, or any combination of any other of the embodiments, aspects or examples. Furthermore, equivalents and modifications not described above may also be employed without departing from the scope of the invention, which is defined in the accompanying claims.

1. A dental apparatus for tooth stain removal comprising:
an elongate body formed of a single piece of plastic, and comprising:
a distal portion of the body having a distal end for contacting a tooth, wherein the distal portion is pointed and angled relative to an axial direction of the body for contacting and removing stains from a tooth; and
a proximal portion of the body configured to attach onto an electric toothbrush drive mechanism such that driving of the electric toothbrush drive mechanism causes the distal portion of the body to vibrate.

2. The dental apparatus of claim 1 wherein the plastic is a polycarbonate.

3. The dental apparatus of claim 2 wherein the polycarbonate comprises between around 10% and 40% glass fibre by weight.

4. The dental apparatus according to claim 1 wherein, in use, vibrations of the dental apparatus from the toothbrush drive mechanism are suitable for cleaning or polishing tooth staining.

5. (canceled)

6. The dental apparatus according to claim 1, wherein the surface area of the distal end is between 0.05 mm² and 2 mm².

7. The dental apparatus according to claim 1, wherein the surface area of the distal end is greater than 0.3 mm².

8. The dental apparatus according to claim 1, wherein the surface area of the distal end is less than 2 mm².

9. The dental apparatus according to claim 1, wherein the distal portion has a generally frustoconical shape.

10. The dental apparatus according claim 1, configured such that driving of the electric toothbrush drive mechanism causes the distal end of the body to vibrate with a frequency of between 100 Hz and 500 Hz.

11. (canceled)

12. The dental apparatus according to claim 1, wherein the proximal portion of the body comprises a cavity configured to receive the electric toothbrush drive mechanism.

13. The dental apparatus according to claim 1, further comprising:
an internal cavity for transporting a fluid within the body; and
an aperture at the distal pointed end for expelling the fluid.

14. The dental apparatus according to claim 13, wherein the aperture at the distal pointed end for expelling has a length of between around 0.5 mm and 1 mm.

15. (canceled)

16. The dental apparatus of claim 13, further comprising a reservoir for holding the fluid.

17. The dental apparatus according to claim 1, further comprising a coupling mechanism to attach the body to the toothbrush drive mechanism and wherein the coupling mechanism is a click-fit or a snap-fit.

18. (canceled)

19. A scaler tip for a dental scaler comprising:
an elongate body formed of a single piece of plastic comprising:
a distal portion of the body having a distal end for contacting a tooth, wherein the distal portion is pointed and angled relative to an axial direction of the body for contacting and scaling a tooth; and
a proximal portion of the body configured to couple to a drive mechanism such that driving of the drive mechanism causes the distal portion of the body to vibrate.

20. The scaler tip of claim 19 wherein the plastic is a polycarbonate.

21. The scaler tip of claim 20 wherein the polycarbonate comprises between around 10% and 40% glass fibre by weight.

22. The scaler tip according to claim 19, wherein the distal end is configured to vibrate with a frequency of 20 KHz or over.

23. The scaler tip according to claim 19, further comprising:
an internal cavity for transporting a fluid within the body; and
an aperture in the distal end for expelling the fluid.

24. (canceled)

25. The dental apparatus of claim 3 wherein the polycarbonate comprises between around 20% and 30% glass fibre by weight.
